(19) United States
(12) Patent Application Publication
(10) Pub. No.: US 2018/0258322 A1
(43) Pub. Date: Sep. 13, 2018

(54) PROTECTIVE ADHESIVE FILM

(71) Applicant: BASF SE, Ludwigshafen (DE)

(72) Inventors: Christine TONHAUSER, Ludwigshafen (DE); Petra ARNOLD, Birkenau (DE); Holger KERN, Kichardt (DE); Michael GROSS, Mannheim (DE)

(73) Assignee: BASF SE, Ludwigshafen (DE)

(21) Appl. No.: 15/542,131

(22) PCT Filed: Dec. 7, 2015
(86) PCT No.: PCT/EP2015/078754

§ 371 Date: Jul. 7, 2017

(30) Foreign Application Priority Data
Jan. 8, 2015 (EP) 15150404.0

(51) Int. Cl. C09J 7/25; C09J 7/38; C09J 175/04; C08F 220/18

(52) U.S. Cl. CPC C09J 7/25; C09J 7/38; C09J 175/04; C08G 18/706; C09J 2203/314; C08F 2220/1825; C08F 220/18

(57) ABSTRACT

Disclosed herein is a pressure-sensitively adhesive protective film formed from a polymer film coated with a crosslinked pressure-sensitive adhesive composition. The pressure-sensitive adhesive composition contains a pressure-sensitive adhesive polymer which is formed by emulsion polymerization in the presence of saccharified starch from soft monomers which when polymerized as a homopolymer have a glass transition temperature of less than 0° C., from ethylenically unsaturated acids or acid anhydrides, and optionally further monomers different from (i) and (ii). The pressure-sensitive adhesive composition contains defined crosslinkers, with the crosslinking reaction brought about by the crosslinker being at an end before the pressure-sensitively adhesive protective film is adhered to a substrate.

The invention relates to pressure-sensitively adhesive protective films formed from a polymer film coated with a crosslinked pressure-sensitive adhesive composition. The pressure-sensitive adhesive composition comprises a pressure-sensitive adhesive polymer formed by emulsion polymerization in the presence of starch from defined monomers. The pressure-sensitive adhesive composition comprises defined crosslinkers, with the crosslinking reaction brought about by the crosslinker being already at an end before the pressure-sensitively adhesive protective film is adhered to a substrate.

Self-adhesive protective films are polymer films which have a coating of pressure-sensitive adhesive (PSA) and which serve to be adhered temporarily to an article in order to protect its surface from scratches while the article is being transported, for example. PSAs based on aqueous polymer dispersions frequently have disadvantages relative to PSAs based on organic solvents, if they come into contact with water. One example of this is a relatively high level of absorption of water by the film of adhesive, resulting for example in an adverse effect on the adhesive properties or possibly in blushing (whitening) of the adhesive film. This may occur especially with the use of dispersion-based protective-film adhesives in the outdoor environment. The blushing may occur if water penetrates the adhesive film and brings about hazing of the adhesive film. This is optically undesirable. The blushing behavior may correlate with the absorption of water by the adhesive film.

WO 97/17387 describes starch-containing polymer dispersions and their use as laminating adhesive. PSAs or protective films are not described.

US 2002/0161102 describes PSA compositions comprising a synthetic polymer dispersion and also an aqueous dispersion of a degraded, derivatized starch. The polymer dispersion is not prepared in the presence of the starch.

It was an object of the present invention to provide sensitively adhesive protective films in which the PSA is prepared on an aqueous basis, has a bonding profile which is extremely suitable for protective films, and exhibits minimal water absorption by the adhesive film on contact with water. It is desirable, additionally, for the adhesive films to exhibit extremely little blushing behavior on contact with water.

The pressure-sensitively adhesive protective film elucidated in more detail below was found accordingly.

A subject of the invention is a pressure-sensitively adhesive protective film formed from a polymer film coated with a crosslinked pressure-sensitive adhesive composition, the pressure-sensitive adhesive composition comprising at least one pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride,
(iii) optionally further monomers different from (i) and (ii),
   the emulsion polymerization of the monomers taking place in the presence of at least one starch,
   and the pressure-sensitive adhesive composition comprising at least one crosslinker selected from polyisocyanates and polyaziridines, and the crosslinking reaction brought about by the crosslinker is at an end without the pressure-sensitively adhesive protective film being adhered to a substrate.

The weight ratio of starch to crosslinker in the dispersion is preferably from 1:2 to 100:1, or from 2:1 to 100:1, more particularly from 3.5:1 to 40:1 or from 4:1 to 20:1 or from 4:1 to 15:1 or from 4:1 to 12:1.

The wt % figures are based in each case on the sum of all the monomers used in the polymerization.

Another subject of the invention is a process for producing protective films.

Another subject of the invention is a pressure-sensitive adhesive composition usable in the process, in the form of an aqueous polymer dispersion comprising at least one dispersed pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride,
(iii) optionally further monomers different from (i) and (ii),
   the emulsion polymerization of the monomers taking place in the presence of at least one starch,
   and the pressure-sensitive adhesive composition comprising at least one crosslinker selected from polyisocyanates and polyaziridines,
   and the weight ratio of starch to crosslinker in the dispersion preferably being from 1:2 to 100:1, or from 2:1 to 100:1, more particularly from 3.5:1 to 40:1 or from 4:1 to 20:1 or from 4:1 to 15:1 or from 4:1 to 12:1.

A pressure-sensitive adhesive (PSA) is a viscoelastic adhesive whose set film at room temperature (20° C.) in the dry state remains permanently tacky and adhesive. Bonding to substrates takes place instantaneously as a result of gentle applied pressure.

In the text below, the designation “(meth)acryl . . . ” and similar designations are occasionally used as an abbreviated notation for “acryl . . . or methacryl . . . ”. In the designation Cx alkyl (meth)acrylate and analogous designations, x denotes the number of C atoms in the alkyl group.

The glass transition temperature can be determined by differential scanning calorimetry (e.g., ASTM 3418/82, midpoint temperature”).

The crosslinking reaction brought about by the crosslinker is at an end when changes in the adhesive properties can no longer be ascertained, more particularly when the peel strength (measured as per the examples, adhesive polyethylene film bonded to steel test element, measured after 1 minute) is constant. The crosslinking reaction is considered to be at an end in particular after 7 days' storage of the coated protective film, the storage taking place preferably at room temperature. When using polyisocyanate crosslinkers, the progress of the crosslinking reaction may also be followed by means of IR spectroscopy. In the course of crosslinking, there is a decrease in the absorption band typical of NCO groups, around 2272 cm⁻¹, until eventually it has disappeared or has largely disappeared and remains constant.

Room temperature denotes 23° C., unless explicitly indicated otherwise.

The PSA composition is preferably an aqueous dispersion with PSA polymer dispersed therein. The PSA composition comprises preferably from 30 to 75 wt %, more preferably from 45 to 65 wt %, of PSA polymer. The solids content of the PSA composition is preferably 40 to 80, more preferably 45 to 75 wt %.

The PSA polymer is prepared from a first monomer kind (i). The monomer kind (i) is present at not less than 60 wt %, preferably not less than 70 wt %, or not less than 75 wt % and preferably up to 99.9 wt % or up to 99.5 wt %, based on the total amount of the monomers used in preparing the PSA polymer. The soft monomers (i) are preferably selected from acrylic esters, more particularly from C2 to C10 alkyl acrylates, or from C₄ to C₁₀ alkyl acrylates, or from C₄ to C₈ alkyl acrylates. Suitable for example are ethyl acrylate, n-butyl acrylate, n-hexyl acrylate, octyl acrylate, and 2-ethylhexyl acrylate, and also mixtures of these monomers. Preference is given to ethyl acrylate, n-butyl acrylate, and 2-ethylhexyl acrylate and mixtures thereof, particular preference to n-butyl acrylate and 2-ethylhexyl acrylate and mixtures thereof.

The PSA polymer is prepared from a further monomer kind (ii). Monomer kind (ii) may be present at 0.1 to 5 wt %, preferably 0.2 to 4 wt %, or 0.5 to 3 wt %, based on the total amount of the monomers used in preparing the polymer. Monomers (ii) are ethylenically unsaturated acids or ethylenically unsaturated acid anhydrides, and are radically polymerizable. Examples of suitable acid monomers include ethylenically unsaturated carboxylic acids, ethylenically unsaturated sulfonic acids, and vinylphosphonic acid. Ethylenically unsaturated carboxylic acids used are preferably alpha,beta-monoethylenically unsaturated monocarboxylic and dicarboxylic acids having 3 to 6 C atoms in the molecule. Examples thereof are acrylic acid, methacrylic acid, itaconic acid, maleic acid, fumaric acid, crotonic acid, vinylacetic acid, and vinyllactic acid. Examples of suitable ethylenically unsaturated sulfonic acids include vinylsulfonic acid, styrenesulfonic acid, acrylamidomethylpropanesulfonic acid, sulfopropyl acrylate, and sulfopropyl methacrylate. Preference is given to acrylic acid and methacrylic acid and mixtures thereof, particular preference to acrylic acid.

The adhesive polymer may be constructed from further monomers (iii), which are different from the monomers (i) and (ii). The monomers (iii) are therefore not monomers which when polymerized as a homopolymer have a glass transition temperature of less than 0° C., and they are not ethylenically unsaturated acids or ethylenically unsaturated acid anhydrides. The monomers (iii) may be used, for example, in amounts of up to 30 wt %, e.g., from 0 to 30 wt %, or from 0.1 to 10 wt %, preferably from 1 to 5 wt %.

The further monomers (iii) may for example be hard monomers which when polymerized as a homopolymer have a glass transition temperature of more than 0° C. or at least 20° C. or at least 50° C. The further monomers (iii) are copolymerizable ethylenically unsaturated compounds. Suitable examples are those selected from the group consisting of C1 to C20 alkyl (meth)acrylates other than the monomers (i), vinyl esters of carboxylic acids comprising up to 20 C atoms, vinylaromatics having up to 20 C atoms, ethylenically unsaturated nitriles, vinyl halides, vinyl ethers of alcohols comprising from 1 to 10 C atoms, aliphatic hydrocarbons having 2 to 8 C atoms and one or two double bonds, monomers comprising hydroxyl groups, more particularly C₁-C₁₀ hydroxyalkyl (meth)acrylates, (meth)acrylamide, or mixtures of these monomers. C₁-C₁₀ hydroxyalkyl (meth)acrylates have 1-10 C atoms in the hydroxyalkyl groups. Additional further monomers include phenyloxyethyl glycol mono(meth)acrylate, glycidyl (meth)acrylate, aminoalkyl (meth)acrylates such as 2-aminoethyl (meth)acrylate, diacetoneacrylamide (especially in combination with dihydrazides such as adipic dihydrazide, ADDH, as crosslinker), and acetoacetoxyethyl methacrylate. Alkyl groups have preferably from 1 to 20 C atoms. Further monomers may also include crosslinking monomers. Suitable monomers (iii) are, for example, (meth)acrylic acid alkyl esters with a C₁-C₁₀ alkyl radical. Also suitable in particular are mixtures of the (meth)acrylic acid alkyl esters. Vinyl esters of carboxylic acids having 1 to 20 C atoms are, for example, vinyl acetate, vinyl laurate, vinyl stearate, vinyl propionate, and vinyl esters of Versatic acid. Vinylaromatic compounds contemplated include vinyltoluene, alpha- and p-methylstyrene, alpha-butylstyrene, 4-n-butylstyrene, 4-n-decylstyrene, and—preferably—styrene. Examples of nitriles are acrylonitrile and methacrylonitrile. The vinyl halides are ethylenically unsaturated compounds substituted by chlorine, fluorine, or bromine, preferably vinyl chloride and vinylidene chloride. Examples of vinyl ethers include vinyl methyl ether or vinyl isobutyl ether. Preferred vinyl ethers are those of alcohols comprising 1 to 4 C atoms. Suitable hydrocarbons having 4 to 8 C atoms and two olefinic double bonds are, for example, butadiene, isoprene, and chloroprene. Preferred as further monomers (iii) are C₁ to C₁₀ alkyl (meth)acrylates, more particularly methyl acrylate, tert-butyl acrylate, and C₁ to C₈ alkyl methacrylates, and vinyl esters, especially vinyl acetate, and mixtures thereof, and also C2 to C10 hydroxyalkyl (meth)acrylates. Especially preferred are methyl acrylate, methyl (meth)acrylate, vinyl acetate, and hydroxypropyl acrylate, and also mixtures of these monomers. Preferred monomers (iii) are, in particular, behenyl (meth)acrylate, cyclohexyl (meth)acrylate, 4-hydroxybutyl acrylate, isobutyl acrylate, tert-butyl (meth)acrylate, tert-butylaminoethyl methacrylate, ureidomethacrylate, and mixtures thereof.

The preparation of the adhesive polymers by emulsion polymerization is undertaken in the presence of at least one starch. Starch is also taken to include modified or degraded starch. In the emulsion polymerization, the starch may be introduced in the initial charge, partly introduced in the initial charge and partly metered in, or metered in entirely during the emulsion polymerization. At an achieved conversion of 80% of the monomers to be polymerized, the polymerization batch advantageously comprises at least half of the total amount of starch. With particular preference the entire amount of starch is introduced in the initial charge in the polymerization. The total amount of starch is preferably 0.1 to 50 parts by weight or 1 to 50 parts by weight, more preferably 1 to 20 parts by weight or 2 to 10 parts by weight, based on 100 parts by weight of monomers. The amount by weight of the hydroxyl groups present in total in the starch is preferably 0.1 to 60 wt %, preferably 2 to 50 wt %, based on the starch.

The weight-average molar weight of the starch is preferably 500 to 50 000 and more preferably from 1000 to 25 000, measured by gel permeation chromatography. The starch may be soluble in water or only dispersible therein. Suitable starches include those known as swellable starches, which are obtainable for example by hydrothermal treatment of native starch. Also suitable are thin-boiling starches. These are starches which have been slightly degraded with acids or enzymes, or oxidized with mild oxidizing agents, and which when boiled with water do not form viscous gels but relatively thin liquids, even at high concentrations. Additionally suitable are acid-modified starches, which are obtained by heating an aqueous starch suspension below the gelatinization temperature in the presence of small amounts of acid. Moreover, oxidatively modified starches are contemplated. Oxidizing agents employed may be, for example, chromic acid, permanganate, hydrogen peroxide, nitrogen dioxide, hypochlorite, or periodic acid. The starting starches suitable are in principle all native starches such as cereal starches (e.g., corn, wheat, rice, or millet), tuber and root starches (e.g. potatoes, tapioca roots, or arrowroot), or sago starches. It is advantageous for roast dextrins to be used, of the kind described in EP-A 408 099 and also in EP-A 334 515, for example. They are obtainable by heating moist-dry starch, generally in the presence of small amounts of acid. Examples of typical roast dextrins are commercially available white and yellow dextrins. The term dextrin here is used very generally for starch degradation products. With very particular advantage, however, the radical emulsion polymerization is carried out in the presence of saccharified starches. These are a starch degradation product obtainable by hydrolysis in aqueous phase. The results are aqueous polymer dispersions which as well as high mechanical and thermal stability also have good rheological properties even after storage. More detailed information on the preparation of said starches and starch derivatives is found in G. Tegge, Stärke and Stärkederivate, Behr's Verlag, Hamburg 1984. It will be appreciated that said starches and starch derivatives may be used, in accordance with the invention, in a form modified chemically by etherification or esterification. This chemical modification may be carried out on the starting starch itself, prior to its degradation, or thereafter. Esterifications are possible with both organic and inorganic acids, their anhydrides or chlorides. Of particular interest are phosphated and acetylated derivatives. The most common method for etherification is that of treatment with organic halogen compounds, epoxides, or sulfates, in aqueous alkaline solution. Particularly suitable ethers are alkyl ethers, hydroxyalkyl ethers, carboxyalkyl ethers, and allyl ethers. Additionally contemplated are cyanoalkylated derivatives and also reaction products with 2,3-epoxypropyltrimethylammonium chloride. Preference is given nevertheless to products which have not undergone chemical modification. Also suitable are degradation products of cellulose, examples being cellobiose and oligomers thereof.

The saccharified starches (degraded starches, maltodextrins) which are to be employed with particular preference in accordance with the invention are available commercially as such, under the designations C Plus or C-Star Sweet from Cargill or from Roquette, for example. Saccharified starches of these kinds are chemically different from the roast dextrins in that inter alia there is substantially no possibility of recombination and branching in the case of hydrolytic degradation in an aqueous medium (typically suspensions or solutions), this degradation being performed generally at solids contents of 10 to 30 wt % and also, preferably, with acidic or enzymic catalysis, and this impossibility of recombination and branching is manifested not least in different molecular weight distributions. Thus, saccharified starches having a bimodal molecular weight distribution have proven particularly advantageous in accordance with the invention. The preparation of saccharified starches is general knowledge and is described in references including G. Tegge, Stärke and Stärkederivate, Behr's Verlag, Hamburg 1984, p. 173 and p. 220 ff., and also in EP-A 441 197. The saccharified starches are normally completely soluble in water at room temperature, with the solubility limit lying generally at above 50 wt %, this being particularly advantageous for the preparation of the aqueous polymer dispersions. A further advantage is if the weight fraction of the saccharified starches having a molecular weight below 1000 is at least 10 wt %, but not more than 70 wt %. It is advisable, furthermore, to use those saccharified starches whose dextrose equivalent, DE, is at least 1 or at least 5 or at least 10 and up to 40 or up to 25, as for example from 1 to 40 or from 1 to 25. The DE value characterizes the reducing power relative to the reducing power of anhydrous dextrose, and is determined according to DIN 10 308 edition 5.71 of the Standards Committee on Foods and Agricultural Products (cf. also Günther Tegge, Stärke and Stärkederivate, Behr's Verlag, Hamburg 1984, p. 305). It has emerged, moreover, that aqueous polymer dispersions particularly favorable in terms of their profile of properties are obtained when saccharified starches are used whose 40 wt % strength aqueous solutions at 25° C. under a shear gradient of 75 s⁻¹ have a dynamic viscosity η⁴⁰ [Pa s] as determined according to DIN 53 019 of 0.005 to 0.06, preferably of 0.005 to 0.03.

The PSA polymers are obtainable by radical polymerization of ethylenically unsaturated compounds (monomers). The polymers are prepared preferably by emulsion polymerization, and are therefore preferably emulsion polymers. In the emulsion polymerization, ethylenically unsaturated compounds (monomers) are polymerized in water, using ionic and/or nonionic emulsifiers and/or protective colloids, or stabilizers, as surface-active compounds for stabilizing the monomer droplets and the polymer particles formed subsequently from the monomers. The surface-active substances are used customarily in amounts of 0.1 to 10 parts by weight, preferably 0.2 to 5 parts by weight, based on 100 parts by weight of the monomers to be polymerized.

A comprehensive description of suitable protective colloids is found in Houben-Weyl, Methoden der organischen Chemie, volume XIV/1, Makromolekulare Stoffe [Macromolecular compounds], Georg-Thieme-Verlag, Stuttgart, 1961, pp. 411 to 420. Emulsifiers contemplated include anionic, cationic, and nonionic emulsifiers. Surface-active substances used are preferably emulsifiers, whose molecular weights, in contrast to those of the protective colloids, are customarily below 2000 g/mol. Where mixtures of surface-active substances are used, the individual components must of course be compatible with one another, something which in case of doubt can be checked using a few preliminary tests. Surface-active substances used are preferably anionic and nonionic emulsifiers. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid, and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula

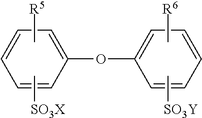

in which R5 and R6 are hydrogen or C4 to C14 alkyl and not simultaneously hydrogen, and X and Y may be alkali metal ions and/or ammonium ions. Preferably, R5 and R6 are linear or branched alkyl radicals having 6 to 18 C atoms or hydrogen, and in particular having 6, 12, and 16 C atoms, with R5 and R6 not both simultaneously being hydrogen. X and Y are preferably sodium, potassium, or ammonium ions, with sodium being particularly preferred. Particularly advantageous compounds are those in which X and Y are sodium, R5 is a branched alkyl radical having 12 C atoms, and R6 is hydrogen or R5. Use is frequently made of technical mixtures having a fraction of 50 to 90 wt % of the monoalkylated product. Commercial products of suitable emulsifiers are, for example, Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol® VSL, Emulphor® NPS 25. For the present invention, ionic emulsifiers or protective colloids are preferred. With particular preference they are ionic emulsifiers, more particularly salts and acids, such as carboxylic acids, sulfonic acids, and sulfates, sulfonates or carboxylates. In particular, use may also be made of mixtures of ionic and nonionic emulsifiers.

The emulsion polymerization may be started using water-soluble initiators. Water-soluble initiators are, for example, ammonium salts and alkali metal salts of peroxodisulfuric acid, sodium peroxodisulfate for example, hydrogen peroxide, or organic peroxides, tert-butyl hydroperoxide for example. Other suitable initiators include those called reduction-oxidation (redox) initiator systems. The redox initiator systems consist of at least one, usually inorganic reducing agent and an organic or inorganic oxidizing agent. The oxidizing component comprises, for example, the initiators already stated above for the emulsion polymerization. The reducing components comprise, for example, alkali metal salts of sulfurous acid, such as sodium sulfite, sodium hydrogensulfite, alkali metal salts of disulfurous acid such as sodium disulfite, bisulfite addition compounds of aliphatic aldehydes and ketones, such as acetone bisulfite, or reducing agents such as hydroxymethanesulfinic acid and its salts, or ascorbic acid. The redox initiator systems may be used along with soluble metal compounds whose metallic component is able to exist in a plurality of valence states. Examples of customary redox initiator systems include ascorbic acid/iron(II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid and sodium disulfite.

The stated initiators are used usually in the form of aqueous solutions, with the lower concentration being determined by the amount of water that is acceptable in the dispersion, and the upper concentration by the solubility of the respective compound in water. Generally speaking, the concentration of the initiators is 0.1 to 30 wt %, preferably 0.5 to 20 wt %, more preferably 1.0 to 10 wt %, based on the monomers to be polymerized. It is also possible for a plurality of different initiators to be used in the emulsion polymerization.

In the polymerization, chain transfer agents may be used, in amounts for example of from 0.01 to 0.8 part by weight, or from 0.01 to 0.1 part by weight, per 100 parts by weight of the monomers to be polymerized. Using these agents, through a chain termination reaction, the molar mass of the emulsion polymer can be controlled or reduced. These agents are bonded to the polymer in the process, generally to the chain end. Suitable chain transfer agents are, for example, organic compounds containing sulfur in bonded form (e.g., compounds with a thiol group), aliphatic and/or araliphatic halogen compounds, aliphatic and/or aromatic aldehydes, unsaturated fatty acids (e.g., oleic acid), dienes having nonconjugated double bonds (such as divinylmethane, terpinolene, or vinylcyclohexene, for example), hydrocarbons having readily abstractable hydrogen atoms (such as toluene, for example), organic acids and/or their salts (such as formic acid, sodium formate, ammonium formate, for example), alcohols (such as isopropanol, for example), and phosphorus compounds (such as sodium hypophosphite, for example). Also possible, however, is the use of mixtures of mutually nondisrupting chain transfer agents as stated above. The chain transfer agents are generally low molecular mass compounds with a molar weight of less than 2000, more particularly of less than 1000 g/mol. It is advantageous to supply a portion or the entirety of the chain transfer agents to the aqueous reaction medium before the radical polymerization is initiated. Furthermore, a portion or the entirety of the radical chain transfer compound may also be advantageously supplied to the aqueous reaction medium together with the monomers, during the polymerization.

Organic compounds having a thiol group are, for example, primary, secondary or tertiary aliphatic thiols, such as, for example, ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and its isomeric compounds, n-octanethiol and its isomeric compounds, n-nonanethiol and its isomeric compounds, n-decanethiol and its isomeric compounds, n-undecanethiol and its isomeric compounds, n-dodecanethiol and its isomeric compounds, n-tridecanethiol and its isomeric compounds, substituted thiols, such as, for example, 2-hydroxyethanethiol, aromatic thiols, such as benzenethiol, ortho-, meta-, or para-methylbenzenethiol, carboxylic acid mercaptoalkyl esters of, for example, C2 to C4 carboxylic acids, having 1 to 18 C atoms in the alkyl group, as for example 2-mercaptoethyl propionate, and also all further sulfur compounds described in Polymer Handbook, 3rd edition, 1989, J. Brandrup and E. H. Immergut, John Wiley & Sons, Section II, pages 133 to 141. Preferred organic compounds comprising sulfur in bonded form are, in particular, tert-butyl mercaptan, ethyl thioglycolate, mercaptoethanol, mercaptopropyltrimethoxysilane, tert-dodecyl mercaptan, thiodiglycol, ethylthioethanol, di-n-butyl sulfide, di-n-octyl sulfide, diphenyl sulfide, diisopropyl disulfide, 2-mercaptoethanol, 1,3-mercaptopropanol, 3-mercaptopropane-1,2-diol, 1,4-mercaptobutanol, thioglycolic acid, 3-mercaptopropionic acid, mercaptosuccinic acid, thioacetic acid, and thiourea. Particularly preferred thio compounds are tert-butyl mercaptan, ethyl thioglycolate, mercaptoethanol, mercaptopropyltrimethoxysilane or tert-dodecyl mercaptan.

Aliphatic and/or araliphatic halogen compounds are, for example, n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide. Aliphatic and/or aromatic aldehydes are, for example, formaldehyde, acetaldehyde, propionaldehyde and/or benzaldehyde.

The emulsion polymerization takes place in general at 30 to 130° C., preferably at 50 to 90° C. The polymerization medium may consist either of water alone or else of mixtures of water and liquids miscible therewith such as methanol. Preference is given to using water alone. The emulsion polymerization may be carried out either as a batch operation or in the form of a feed process, including staged or gradient regimes. The feed process is preferred, in which a portion of the polymerization batch is introduced as an initial charge, and is heated to the polymerization temperature and its polymerization commenced, and then the remainder of the polymerization batch is supplied to the polymerization zone, customarily via a plurality of spatially separate feeds, of which one or more comprise the monomers in pure form or in emulsified form, this supply taking place continuously, in stages, or subject to a concentration gradient, with the polymerization being maintained. In the polymerization it is also possible for a polymer seed to be included in the initial charge, for the purpose of more effective setting of the particle size, for example.

The manner in which the initiator is added to the polymerization vessel in the course of the radical aqueous emulsion polymerization is known to a person of ordinary skill in the art. It may either be included in its entirety in the initial charge to the polymerization vessel, or introduced continuously or in stages at the rate at which it is consumed in the course of the radical aqueous emulsion polymerization. Individually, this is dependent on the chemical nature of the initiator system and also on the polymerization temperature. Preference is given to including part in the initial charge and supplying the remainder to the polymerization zone at the rate at which it is consumed. In order to remove the residual monomers, it is customary to add initiator after the end of the actual emulsion polymerization as well, i.e., after a monomer conversion of at least 95%. In the case of the feed process, the individual components may be added to the reactor from above, at the side, or from below, through the reactor bottom.

In the emulsion polymerization, aqueous dispersions of the polymer with solids contents generally of 15 to 75 wt %, preferably of 40 to 75 wt %, are obtained. For a high space/time yield of the reactor, dispersions with an extremely high solids content are preferred. In order to be able to achieve solids contents >60 wt %, a bimodal or poly-modal particle size ought to be established, since otherwise the viscosity becomes too high and the dispersion can no longer be managed. Producing a new generation of particles can be accomplished, for example, by adding seed (EP 81083), by adding excess amounts of emulsifier, or by adding miniemulsions. Another advantage associated with the combination of low viscosity and high solids content is the improved coating characteristics at high solids contents. Producing one or more new generations of particles is something which can be done at any point in time. This time is guided by the particle size distribution that is desired for a low viscosity.

The polymer thus prepared is used preferably in the form of its aqueous dispersion. The size distribution of the dispersion particles may be monomodal, bimodal or multimodal. By average particle size here is meant the d₅₀ of the particle size distribution, meaning that 50 wt % of the total mass of all particles have a particle diameter smaller than the d₅₀. The particle size distribution can be determined in a known way using an analytical ultracentrifuge (W. Machtle, Makromolekulare Chemie 185 (1984), pp. 1025-1039). In the case of bimodal or multimodal particle size distribution, the particle size may be up to 1000 nm. The pH of the polymer dispersion is set preferably at a pH greater than 3.5, more particularly at a pH of between 3.5 and 8. The glass transition temperature of the pressure-sensitive adhesive polymer is preferably less than or equal to 0° C., more preferably −60° to 0° C. or −60 to −10° C., and very preferably −55 to −20° C. The glass transition temperature may be determined by means of differential scanning calorimetry (e.g., ASTM 3418/82, midpoint temperature).

The dispersion of the radically polymerized polymer comprises at least one crosslinker, selected from polyisocyanates and polyaziridines. In accordance with the present application, the crosslinkers may be used individually or as mixtures of two or more crosslinkers. This crosslinking occurs entirely or predominantly with the hydroxyl groups of the starch. Because of the crosslinking reaction that ensues, the addition of the crosslinker is not made until shortly before the subsequent use of the dispersion, i.e., shortly before the coating of the polymer film. Following addition of the crosslinker, there remains sufficient time, generally up to 8 hours, for processing.

Suitable polyisocyanates are, for example, aliphatic or cycloaliphatic or aromatic diisocyanates or polyisocyanates of higher functionality deriving from the diisocyanates. Examples of polyisocyanates contemplated include linear or branched C4-C14 alkylene diisocyanates, cycloaliphatic diisocyanates having in total 6 to 12 C atoms, aromatic diisocyanates having in total 8 to 14 C atoms, polyisocyanates containing isocyanurate groups, uretdione diisocyanates, polyisocyanates containing biuret groups, polyisocyanates containing urethane or allophanate groups, polyisocyanates comprising oxadiazine trione groups, uretonimine-modified polyisocyanates, or mixtures thereof. Examples of diisocyanates include aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, trimethylhexane diisocyanate or tetramethylhexane diisocyanate; cycloaliphatic diisocyanates such as 1,4-, 1,3- or 1,2-diisocyanatocyclohexane, 4,4′-di(isocyanatocyclohexyl)methane, 1-isocyanato-3,3,5-trimethyl-5-(isocyanatomethyl)cyclohexane (isophorone diisocyanate), or 2,4- or 2,6-diisocyanato-1-methylcyclohexane, or aromatic diisocyanates such as 2,4-diisocyanatotoluene, 2,6-diisocyanatotoluene, tetramethylxylylene diisocyanate, 1,4-diisocyanatobenzene, 4,4′- or 2,4-diisocyanatodiphenylmethane, p-xylylene diisocyanate, and also isopropenyl-dimethyltolylene diisocyanate. Polyisocyanates include, for example, polycyclic homologs of the aromatic diisocyanates stated above.

Mention may further be made of the following:
a) Polyisocyanates containing isocyanurate groups and derived from aromatic, preferably aliphatic and/or cycloaliphatic diisocyanates. Particularly preferred in this context are the corresponding isocyanato-isocyanurates based on hexamethylene diisocyanate and isophorone diisocyanate. The present isocyanurates are, in particular, simple trisisocyanatoalkyl and/or trisisocyanatocycloalkyl isocyanurates, which represent cyclic trimers of the diisocyanates, or are mixtures with their higher homologs containing more than one isocyanurate ring. The isocyanato-isocyanurates generally have an NCO content of 10 to 30 wt %, more particularly 15 to 25 wt %, and an average NCO functionality of 3 to 4.5.
b) Uretdione diisocyanates having aromatic, preferably aliphatically and/or cycloaliphatically bonded isocyanate groups, derived preferably from hexamethylene diisocyanate or isophorone diisocyanate. Uretdione diisocyanates are cyclic dimerization products of diisocyanates.
c) Polyisocyanates containing biuret groups and having aromatic, preferably aliphatically bonded isocyanate groups, more particularly tris(6-isocyanatohexyl)biuret or its mixtures with its higher homologs. These polyisocyanates containing biuret groups generally have an NCO content of 18 to 22 wt % and an average NCO functionality of 3 to 3.5 or up to 4.5.
d) Polyisocyanates containing urethane groups and/or allophanate groups and having aromatic, preferably aliphatically or cycloaliphatically bonded isocyanate groups, of the kind obtainable for example by reaction of excess amounts of hexamethylene diisocyanate or of isophorone diisocyanate with simple polyhydric alcohols such as trimethylolpropane, glycerol or 1,2-dihydroxypropane, for example, or mixtures thereof. These polyisocyanates containing urethane groups and/or allophanate groups generally have an NCO content of 12 to 20 wt % and an average NCO functionality of 2.5 to 3.
e) Polyisocyanates comprising oxadiazinetrione groups, derived preferably from hexamethylene diisocyanate or from isophorone diisocyanate. Polyisocyanates of this kind comprising oxadiazinetrione groups are preparable from diisocyanate and carbon dioxide.
f) Uretonimine-modified polyisocyanates.

The polyisocyanates a) to f) may also be used in a mixture, including optionally a mixture with diisocyanates. Preference is given to aliphatic and/or cycloaliphatic polyisocyanates, and/or diisocyanates.

Particularly preferred are hydrophilically modified polyisocyanates which are self-dispersible in water. For the preparation of the self-dispersible polyisocyanates, the polyisocyanates identified above are reacted with compounds containing at least one, preferably one, hydrophilic group, which may be ionic or nonionic, and at least one, preferably one, isocyanate-reactive group, such as a hydroxyl, mercapto or primary or secondary amino group (NH group for short), for example. The hydrophilic group may be, for example, an ionic group or a group which can be converted into an ionic group. Anionic groups or groups which can be converted into anionic groups are, for example, carboxylic or sulfonic acid groups. Examples of suitable compounds are hydroxycarboxylic acids, such as hydroxypivalic acid or dimethylolpropionic acid, or hydroxysulfonic acids or aminosulfonic acids. Cationic groups or groups which can be converted into cationic groups are, for example, quaternary ammonium groups and tertiary amino groups. Groups which can be converted into ionic groups are preferably converted into ionic groups before or during the dispersing of the mixture of the invention in water. For the conversion, for example, of carboxylic or sulfonic acid groups into anionic groups, use may be made of inorganic and/or organic bases such as sodium hydroxide, potassium hydroxide, potassium carbonate, sodium hydrogencarbonate, ammonia, or primary, secondary, and especially tertiary amines, e.g., triethylamine or dimethylaminopropanol. For the conversion of tertiary amino group into the corresponding cations, ammonium groups for example, neutralizing agents that are suitable are inorganic or organic acids, as for example hydrochloric acid, acetic acid, fumaric acid, maleic acid, lactic acid, tartaric acid, oxalic acid or phosphoric acid, or suitable quaternizing agents are, for example, methyl chloride, methyl iodide, dimethyl sulfate, benzyl chloride, ethyl chloroacetate or bromoacetamide. Further suitable neutralizing and quaternizing agents are described in U.S. Pat. No. 3,479,310, column 6, for example. The amount of the ionic groups or groups which can be converted into ionic groups is preferably 0.1 to 3 mol per kg of the polyisocyanates that are self-dispersible in water. Nonionic hydrophilic groups are, for example, polyalkylene ether groups, especially those having 10 to 80 alkylene oxide units. Preference is given to polyethylene ether groups or polyalkylene ether groups which as well as other alkylene oxide units, propylene oxide for example, comprise at least 10 ethylene oxide units. Suitable compounds are, for example, polyalkylene ether alcohols. The amount of the hydrophilic nonionic groups, more particularly of the polyalkylene ether groups, is preferably 0.5 to 20, more preferably 1 to 15 wt %, based on the polyisocyanates that are self-dispersible in water. The preparation of the polyisocyanates that are self-dispersible in water is known from DE-A-35 21 618, DE-A-40 01 783, and DE-A-42 03 510. In the preparation of the polyisocyanates that are self-dispersible in water, the compounds having at least one hydrophilic group and at least one isocyanate-reactive group may be reacted with a portion of the polyisocyanate, and the resulting hydrophilically modified polyisocyanates may then be mixed with the remaining polyisocyanates. An alternative mode of the preparation is for the compounds to be added to the total amount of the polyisocyanates and then for the reaction to be carried out in situ. Preferred water-emulsifiable polyisocyanates are those having hydrophilic nonionic groups, more particularly polyalkylene ether groups. Here, preferably, the water-emulsifiability is achieved solely by virtue of the hydrophilic nonionic groups.

As crosslinkers it is also possible to use polyaziridines. These are polyfunctional aziridine compounds having at least two aziridine groups. The aziridine groups may be substituted on the nitrogen atom, by an alkyl, alkenyl, aryl or aralkyl radical, for example. Suitability is possessed for example by aziridine crosslinkers based on polyethers or on substituted hydrocarbons, as for example 1,6-bis-N-aziridinohexane. The polyfunctional aziridine compound present in the composition of the invention may be selected preferably from the group consisting of the Michael addition products of optionally substituted ethyleneimine onto esters of polyhydric alcohols with alpha,beta-unsaturated carboxylic acids, and the addition products of optionally substituted ethyleneimine onto polyisocyanates. Examples of suitable polyhydric alcohol components are trimethylolpropane, neopentyl glycol, glycerol, pentaerythritol, 4,4′-isopropylidenediphenol, and 4,4′-methylenediphenol. Suitable alpha,beta-unsaturated carboxylic acids include, for example, acrylic and methacrylic acid, crotonic acid, and cinnamic acid. With particular preference the composition of the invention comprises acrylic esters. The corresponding polyhydric alcohols of the alpha,beta-unsaturated carboxylic esters may optionally be alcohols which have been singly or multiply extended at their OH functions, partly or completely, with alkylene oxides. These may be the aforementioned alcohols singly or multiply extended with alkylene oxides, for example. Particularly suitable alkylene oxides are ethylene oxide and propylene oxide. Examples of suitable polyaziridines are trimethylolpropane tris(betaaziridino)propionate, neopentyl glycol di(beta-aziridino)propionate, glycerol tris(betaaziridino)propionate, pentaerythritol tetra(beta-aziridino)propionate, 4,4′-isopropylidenediphenol di(beta-aziridino)propionate, 4,4′-methylenediphenol di(betaaziridino)propionate, 1,6-hexamethylenedi(N,N-ethyleneurea), 4,4′-methylenebis(phenyl-N,N-ethyleneurea), 1,3,5-tris(omega-hexamethylene-N,N-ethyleneurea)biuret, and mixtures thereof. The polyfunctional aziridine compounds may optionally be substituted on their aziridine units.

The amount of the crosslinkers is preferably from 0.05 to 10 parts by weight, more preferably 0.5 to 5 parts by weight, based on the sum of the weight fractions of the at least one starch and of the at least one PSA polymer.

The PSA composition comprises preferably from 0.05 to 10 wt %, more preferably from 0.1 to 3 wt %, of the at least one crosslinker.

The protective film is preferably one where the PSA composition comprises at least one PSA polymer formed by emulsion polymerization from
(i) 60 to 99.9 wt %, based on the sum of the monomers, of at least one soft monomer selected from the group consisting of n-butyl acrylate, ethyl acrylate, and 2-ethylhexyl acrylate, and mixtures of these monomers,
(ii) 0.1-5 wt %, based on the sum of the monomers, of at least one monomer selected from the group consisting of acrylic acid, methacrylic acid and mixtures of these monomers,
(iii) 0 to 30 wt % of monomers different from (i) and (ii), selected from the group consisting of C1 to C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, monomers comprising hydroxyl groups, (meth)acrylamide, phenyloxyethyl glycol mono(meth)acrylate, glycidyl (meth)acrylate, aminoalkyl (meth)acrylates, diacetoneacrylamide (in particular in combination with dihydrazides, such as adipic acid dihydrazide ADDH as crosslinker), and acetoacetoxyethyl methacrylate, and mixtures of these monomers,
   the emulsion polymerization of the monomers taking place in the presence of at least one starch in an amount of 0.1 to 50 parts by weight, based on 100 parts by weight of monomers of the pressure-sensitive adhesive polymer,
   and the pressure-sensitive adhesive composition comprising at least one crosslinker selected from polyisocyanates and polyaziridines,
   the weight ratio of starch to crosslinker in the dispersion being preferably from 1:2 to 100:1 or from 2:1 to 100:1, more particularly from 3.5:1 to 40:1 or from 4:1 to 20:1 or from 4:1 to 15:1 or from 4:1 to 12:1.

By setting the weight ratio of starch to crosslinker it is possible in particular to improve the blushing characteristics of the film of adhesive on contact with water.

The pressure-sensitive adhesive compositions may consist solely of the PSA polymer or of the aqueous dispersion of the PSA polymer and also of the crosslinker. Additionally, however, the PSA composition may include further adjuvants as well, examples being fillers, dyes, flow control agents, thickeners, preferably associative thickeners, defoamers, further crosslinkers, plasticizers, pigments, wetting agents, or tackifiers (tackifying resins). Tackifiers are known, for example, from Adhesive Age, July 1987, pages 19-23 or Polym. Mater. Sci. Eng. 61 (1989), pages 588-592. For more effective wetting of surfaces, the PSAs may comprise, in particular, wetting assistants (wetting agents), examples being fatty alcohol ethoxylates, alkylphenol ethoxylates, nonylphenol ethoxylates, polyoxyethylenes/propylenes, or sodium dodecylsulfonates. The amount of adjuvants is generally 0.05 to 5 parts by weight, more particularly 0.1 to 3 parts by weight, per 100 parts by weight of polymer (solid).

A tackifier is a polymeric or oligomeric adjuvant for adhesive polymers or, generally, for elastomers, which increases their autoadhesion (tack, inherent stickiness, self-adhesion), meaning that they adhere firmly to surfaces after brief, gentle applied pressure. Tackifiers are, for example, natural resins, such as rosins, and their derivatives formed by disproportionation or isomerization, polymerization, dimerization and/or hydrogenation, or terpene resins. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanetriol, and pentaerythritol. Also used, furthermore, are hydrocarbon resins, examples being coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, alpha-methylstyrene, and vinyltoluene.

Also being used increasingly as tackifiers are polyacrylates which have a low molar weight. These polyacrylates preferably have a weight-average molecular weight M_{w} below 50 000, more particularly below 30 000. The polyacrylates consist preferably to an extent of at least 60 wt %, more particularly at least 80 wt %, of C₁-C₈ alkyl (meth)acrylates. Suitability is possessed, for example, by the low molecular mass polymers and oligomers described in WO 2013/117428, having a weight-average molecular weight of less than 50 000 and a glass transition temperature of greater than or equal to −40° C. to less than or equal to 0° C., preferably of greater than or equal to −35° C. to less than or equal to 0° C., preparable by emulsion polymerization in the presence of at least one chain transfer agent and preparable from a monomer mixture comprising at least 40 wt % of at least one C1 to C20 alkyl (meth)acrylate.

Preferred tackifiers are natural or chemically modified rosins. Rosins consist predominantly of abietic acid or derivatives of abietic acid. The tackifiers can be added simply to the polymer dispersion. In this case the tackifiers themselves are preferably in the form of an aqueous dispersion. The amount by weight of the tackifiers is preferably 5 to 100 parts by weight, more preferably 10 to 50 parts by weight, based on 100 parts by weight of polymer (solid/solid).

The PSA compositions are dispersions of polymers in an aqueous medium. The aqueous medium may comprise, for example, fully demineralized water, or else mixtures of water and a solvent miscible therewith such as methanol, ethanol or tetrahydrofuran. With preference no organic solvents are used. The solids contents of the PSA compositions are preferably from 15 to 75 wt %, more preferably from 40 to 60 wt %, more particularly greater than 50 wt %. The pH of the adhesive compositions is set preferably at a pH of more than 3.5, more particularly at a pH of between 3.5 and 9.

The PSA composition may be used for producing pressure-sensitively adhesive protective films. Another subject of the invention, accordingly, is a process for producing protective films, in which a pressure-sensitive adhesive composition is provided, the pressure-sensitive adhesive composition comprising at least one pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride,
(iii) optionally further monomers different from (i) and (ii),
   the emulsion polymerization of the monomers taking place in the presence of at least one starch,
   and the pressure-sensitive adhesive composition comprising at least one crosslinker selected from polyisocyanates and polyaziridines,
   the protective film being a polymer film which is coated with the pressure-sensitive adhesive composition, and the crosslinking reaction brought about by the crosslinker is at an end without the pressure-sensitively adhesive protective film being adhered to a substrate.

The protective films are coated at least partly with the PSA. The protective films are preferably removable after having been bonded to substrates. Suitable carrier materials are polymeric films, more particularly thermoplastic polymeric films. Thermoplastic film contemplated includes, for example, films of polyolefins (e.g. polyethylene, polypropylene), polyolefin copolymers, films of polyesters (e.g., polyethylene terephthalate), or polyacetate. These films may be of single-ply or multi-ply construction. The surfaces of the thermoplastic polymer films are preferably corona-treated. The protective films are coated on one side with adhesive. Preferred substrates to which the protective films may be adhered are glass, wood, metal, plastic, textiles, or carpet.

The protective films are preferably transparent or pigmented and preferably have a thickness of 10 to 200 μm.

The PSA composition may be applied to the protective films by customary techniques such as rolling, knifecoating or spreading. The coatweight is preferably 0.1 to 30 g, more preferably 2 to 20 g, of solids per m². Following application, there is generally a drying step for removing the water and/or the solvents. The water may be removed by drying at 23 to 150° C., for example. The coated films obtained in this way are stored until the crosslinking reaction is concluded, as for example after storage for at least 7 days. Storage takes place preferably at room temperature.

Before or after the adhesive has been applied, the films may be trimmed to a form suitable for the intended application. For subsequent use, the PSA-coated side of the film may be lined with a release paper, as for example with a siliconized paper.

### EXAMPLES

Abbreviations used are as follows:
DE Dextrose equivalent
C Plus Maltodextrin C Plus 10998, Cargill, Del. 16.5
C-Sweet C-Star-Sweet 01403, Cargill, degraded starch, glucose syrup, DE 26-32
Roquette Maltodextrin Roquette 1967, Roquette, Del. 18 to 20
Basonat® Basonat® HW 100, water-dispersible polyisocyanate based on isocyanurated hexamethylene diisocyanate, BASF SE
Emuldur® Emuldur® 3643, BASF SE, water-dispersible polyaziridine
Lutavit® C L(+)-Ascorbic acid solution, BASF SE
Dowfax® 2A1 Alkyldiphenyl oxide disulfonate, emulsifier
Disponil® LDBS 20 Emulsifier
pphm Parts by weight per 100 parts by weight of monomer (parts per hundred parts monomers)
SC Solids content
LT Light transmittance; parameter for determination of differences in particle size. The polymer dispersion here is diluted to 0.01% solids content and the light transmittance is measured in comparison to pure water
Tg (calculated) Glass transition temperature calculated by the Fox equation from the glass transition temperature of the homopolymers of the monomers that are present in the copolymer and from their weight fraction:

1/Tg=xA/TgA+xB/TgB+xC/TgC+ . . .
Tg: calculated glass transition temperature of the copolymer
TgA: glass transition temperature of the homopolymer of monomer A
TgB, TgC: Tg correspondingly for monomers B, C, etc.
xA: Mass of monomer A/total mass of copolymer,
xB, xC correspondingly for monomers B, C, etc.

### Example Dispersion 1a

A mixture of 200 g of water, 100 g of a 50% strength maltodextrin solution (C Plus), and 6.06 g of a 30% fine polystyrene seed (in water) is heated to 85° C. and stirred for 5 minutes. Then 10 g of a 2.5% strength sodium peroxodisulfate solution are added, and stirring is repeated for 5 minutes. This is followed by the metering of the monomers over 2 hours and, in parallel, the metering of 40 g of sodium peroxodisulfate (2.5% strength solution in water).

### Monomer Feed 1a:

200 g water
22.22 g Dowfax® 2A1 (45% strength in water)
5 g acrylic acid
495 g n-butyl acrylate

This is followed by postpolymerization of 45 minutes. Thereafter 10 g of a 5% strength hydrogen peroxide solution are added, and 10 g of a 10% strength Lutavit® C solution are metered in over 30 minutes. 30 g of water and 3.6 g of a 12.5% strength ammonia solution are added.

### Example Dispersions 1b, 1c and Comparative Examples 1d, 1e

In examples 1 b-d, with the same polymerization process and monomer composition, the amount of starch added is varied. Example 1 b adds 75 g of maltodextrin solution, example 1c adds 50 g, and example 1d adds no maltodextrin solution, with this example serving as a noninventive reference. In example 1e, 100 g of a 50% strength maltodextrin solution are added to the dispersion from example 1d, after the polymerization and after cooling, and the system is stirred.

### Example Dispersions 2a and 2b

In examples 2a and b, the monomer composition is varied. The maltodextrin quantity and the course of the polymerization are as for example 1a.

Monomer feed 2a:
200 g water
22.22 g Dowfax® 2A1 (45% strength in water)
5 g acrylic acid
250 g n-butyl acrylate
245 g 2-ethylhexyl acrylate

### Monomer Feed 2b:

200 g water
22.22 g Dowfax® 2A1 (45% strength in water)
5 g acrylic acid
410 g n-butyl acrylate
85 g 2-tert-butyl acrylate

### Example Dispersions 3a and 3b

In examples 3a and b, the nature of the starch added is varied. In 3a, instead of the maltodextrin, a much more degraded starch (C-Star-Sweet 01403, as a 50% strength solution) is used; example 3b uses the maltodextrin from Roquette (Roquette 1967, as a 50% strength solution). In both cases the monomer composition and the quantity of starch are analogous to those in example 1a.

### Example Dispersion 4a

In example 4a, instead of Dowfax® 2A1, the emulsifier Disponil® LDBS 20 is used, in an equal quantity. The composition and polymerization conditions are analogous to those in example 1a.

The characteristic values of the example dispersions are described in the table below.

TABLE 1
Wet specimen values of the dispersions from examples 1-4.

| Example | SC [%] | pH | LT | Tg (calculated) |
|---|---|---|---|---|
| 1a | 49.3 | 6.5 | 72 | −42° C. |
| 1b | 51.8 | 5.1 | 73 | −42° C. |
| 1c | 49.6 | 5.1 | 53 | −42° C. |
| 1d comparative | 49.9 | 4.7 | 72 | −42° C. |
| 2a | 50.2 | 4.4 | 70 | −50° C. |
| 2b | 50.6 | 4.8 | 72 | −30° C. |
| 3a | 49.6 | 3.9 | 74 | −42° C. |
| 3b | 49.4 | 4.1 | 74 | −42° C. |
| 4a | 50.4 | 4.9 | 73 | −42° C. |

### Performance Testing

### Production of the Protective Film

The polymer dispersions obtained were investigated for their suitability as PSAs for protective film applications. Both unformulated adhesives and adhesives formulated with crosslinkers are tested. For this purpose, 100 g of each polymer dispersion is admixed dropwise, with stirring, with the quantity of crosslinker indicated in the corresponding tables, and the system is homogenized by further stirring for 5 minutes. Within a maximum of 2 hours, the resulting adhesives are coated using a bar coater directly onto corona-pretreated polyethylene film (film thickness 50 μm), and the coated films are dried in a forced air oven at 90° C. for 3 minutes, then lined with siliconized paper and stored under standard conditions (23° C., 50% relative humidity) for at least 16 hours, in the case of crosslinked adhesives for 7 days, prior to performance testing.

The test specimens each have an adhesive coatweight of (10+/−1) g/m². For investigations of the water absorption and of the blushing behavior, the adhesives are applied to PET film (Hostaphan BN50) with an adhesive coatweight of (15+/−1) g/m²; other conditions of the sample preparation are the same.

### Testing for Suitability as Protective Film Adhesive

### Water Resistance

### a) Water Absorption

Sections with an area of 100 cm² are cut, using a circular cutter, from PET film specimens coated with adhesive as described above, and the silicone paper is removed, and the specimens are weighed on an analytical balance. With knowledge of the adhesive coatweight (15+/−1) g/m², the total amount of adhesive in the dry state is calculated. In a shallow tray, mains water is first conditioned at room temperature for 24 hours. The coated PET film sections are then stored in water, with the adhesive side upward, at room temperature for 24 hours; floating is prevented by weighting with small pieces of brass. The specimens are then removed, adhering water drops are dabbed off immediately with a cotton cloth, and the film disk is folded together by the adhesive side in order to prevent further drying. The specimens are again weighed on the analytical balance. The increase in mass determined is interpreted as water absorption by the adhesive, and is expressed as a percentage relative to the original mass of adhesive.

TABLE 2
Water absorption of the polymer films
after water storage for 24 hours.

| | Monomer | Amount of | Amount of | Water |
|---|---|---|---|---|
| | composition | starch | crosslinker | absorp- |
| | [parts by | [parts by | [parts by | tion |
| Example | weight] | weight], type | weight], type | [%] |
| 1a | 99 nBA, 1AA | 10, C Plus | 0 | 1.7 |
| 1a | 99 nBA, 1AA | 10, C Plus | 1.5 (Basonat ®) | 0.1 |
| 1b | 99 nBA, 1AA | 7.5, C Plus | 0 | 17.6 |
| 1b | 99 nBA, 1AA | 7.5, C Plus | 1.5 (Basonat ®) | 1.1 |
| 1c | 99 nBA, 1AA | 5, C Plus | 0 | 28.0 |
| 1c | 99 nBA, 1AA | 5, C Plus | 1.5 (Basonat ®) | 1.1 |
| 1d | 99 nBA, 1AA | 0 | 0 | 31.2 |
| comparative | | | | |
| 1d | 99 nBA, 1AA | 0 | 1.5 (Basonat ®) | 19.6 |
| comparative | | | | |
| 1e | 99 nBA, 1AA | 10*, C Plus | 0 | 3.1 |
| comparative | | | | |
| 1e | 99 nBA, 1AA | 10*, C Plus | 1.5 (Basonat ®) | 20.0 |
| comparative | | | | |
| 2a | 49 EHA, | 10, C Plus | 0 | 19.2 |
| | 50 nBA, 1 AA | | | |
| 2a | 49 EHA, | 10, C Plus | 1.5 (Basonat ®) | 0.5 |
| | 50 nBA, 1 AA | | | |
| 2b | 17 tBA, | 10, C Plus | 0 | 7.4 |
| | 82 nBA, 1 AA | | | |
| 2b | 17 tBA, | 10, C Plus | 1.5 (Basonat ®) | 0.4 |
| | 82 nBA, 1 AA | | | |
| 3a | 99 nBA, 1AA | 10, C Sweet | 0 | 8.6 |
| 3a | 99 nBA, 1AA | 10, C Sweet | 2.0 (Basonat ®) | 0.5 |
| 3b | 99 nBA, 1AA | 10, Roquette | 0 | 10.6 |
| 3b | 99 nBA, 1AA | 10, Roquette | 2.0 (Basonat ®) | 0.6 |

### b) Blushing Behavior

PET film strips coated with (15+/−1) g/m² adhesive are stored in mains water at room temperature, and any blushing that occurs to the adhesive is assessed visually in qualitative terms after defined intervals as per table 3. Here, a rating of 0=no haze, 1=very slight haze, 2=more pronounced haze, 3=severe haze, and 4=very severe haze.

TABLE 3
Blushing of the polymer films after water storage at different
times, with varying amounts of starch and of crosslinker

| | Amount of | | Blushing, ratings | | |
|---|---|---|---|---|---|
| Dispersion | crosslinker | Starch:crosslinker | 0-4 after | | |
| example | [pphm], type | ratio | 10 min | 1 h | 24 h |
| 1a | 0 | 10:0 | 4 | 4 | 4 |
| 1a | 1 (Basonat ®) | 10:1 | 1 | 1 | 1 |
| 1a | 2 (Basonat ®) | 5:1 | 0 | 0 | 0 |
| 1a | 3 (Basonat ®) | 3.3:1 | 4 | 4 | 4 |
| 1a | 0.3 (Emuldur ®) | 33:1 | 3 | 3 | 3 |
| 1a | 0.6 (Emuldur ®) | 17:1 | 4 | 4 | 2 |
| 1a | 0.9 (Emuldur ®) | 11:1 | 0 | 0 | 0 |
| 1c | 0 | 10:0 | 4 | 4 | 4 |
| 1c | 2 (Basonat ®) | 2.5:1 | 4 | 4 | 4 |
| 1d | 0 | 10:0 | 4 | 4 | 4 |
| comparative | | | | | |
| 1d | 2 (Basonat ®) | 5:1 | 4 | 4 | 4 |
| comparative | | | | | |
| 1e | 0 | 10:0 | 4 | 4 | 4 |
| comparative | | | | | |
| 1e | 1.5 (Basonat ®) | 6.7:1 | 4 | 4 | 4 |
| comparative | | | | | |
| 3a | 0 | 10:0 | 4 | 4 | 4 |
| 3a | 2 (Basonat ®) | 5:1 | 1 | 0 | 0 |
| 3b | 0 | 10:0 | 4 | 4 | 4 |
| 3b | 2 (Basonat ®) | 5:1 | 2 | 1 | 1 |

c) Anchorage after Water Storage

PE strips coated with (10+/−1) g/m² adhesive (specimens as for the determination of the adhesive bonding profile; see below) are stored in mains water at room temperature for 24 hours. If the adhesive subsequently can be rubbed away from the PE film by thumb only with very great difficulty or not at all, the anchorage is assessed as being very good or good. If the adhesive, on the other hand, can be rubbed off with just a little effort, the anchorage is assessed as poor.

TABLE 4
Anchorage of the films of adhesive after 24 h water storage.

| | Amount of crosslinker | |
|---|---|---|
| Example | [%], type | Anchorage to PE^{b} |
| 1a | 0 | very poor |
| 1a | 1.5 (Basonat ® HW 100) | very good |
| 1d comparative | 0 | very poor |
| 1d comparative | 1.5 (Basonat ® HW 100) | poor |
| 3a | 0 | poor |
| 3a | 1.5 (Basonat ® HW 100) | very good |
| 3b | 0 | very poor |
| 3b | 1.5 (Basonat ® HW 100) | very good |

### Adhesive Bonding Profile

### a) Quickstick

In the determination of the quickstick (surface tack, also called loop tack), a determination is made of the force with which an adhesive applied to a carrier material by bonding without pressure onto a substrate opposes removal from the substrate at a defined removal speed. From the carrier coated with adhesive as described above, a test strip 25 mm in width and 250 mm in length is cut and is stored under standard conditions (23° C., 50% relative humidity) for at least 16 hours, in the case of crosslinked adhesives for 7 days. The two ends of the test strip are folded over for a length of approximately 1 cm with the adhesive side inward. A loop is formed from the adhesive strip, with the adhesive side outward, and the two ends are brought together and clamped into the upper jaw of a tensile testing machine. The test substrate mount is clamped into the lower jaw, and the test substrate is inserted. The loop of adhesive strip is run downward through the tensile testing machine at a speed of 300 mm/minute, causing the adhesive side of the test strip to bond to the substrate without additional pressure. The tensile testing machine is halted and is immediately moved upward again when the bottom edge of the upper jaw is 40 mm above the substrate. The test result is reported in N/25 mm width. The maximum value on the display (Fmax) is read off as the measure of the surface tack. An average is formed from at least two individual results.

### b) Shear Strength (Cohesion)

For the determination of the shear strength, the test strips are bonded to sheet steel with a bonded area of 25×25 mm, rolled down once with a roller weighing 1 kg, and, after 10 minutes, loaded in suspension with a 1 kg weight. The shear strength (cohesion) is determined under standard conditions (23° C.; 50% relative humidity). The measure of the shear strength is the time taken, in hours, for the weight to drop; the average is calculated in each case from at least 3 measurements.

### c) Peel Strength (Adhesion)

For the determination of the peel strength (adhesion), a test strip 25 mm wide is adhered in each case to a test element comprising the material characterized in the respective tables, and is rolled down once with a roller weighing 1 kg. The strip is then clamped by one end into the upper jaws of a tensile strain testing apparatus. The adhesive strip is peeled from the test surface at an angle of 180° and at 300 mm/min—that is, the adhesive strip is bent around and pulled off parallel to the test element, and the expenditure of force required to achieve this is recorded. The measure of the peel strength is the force in N/25 mm which results as the average value from at least two measurements. The peel strength is determined 1 minute and 24 hours after bonding. The test methods correspond essentially to Finat test methods (FTM) 1, 8 and 9. Explanation of the fracture mode: “A” corresponds to adhesive fracture at the substrate; in the case of “F”, a slight filmy residue is visible on the substrate surface.

TABLE 5
Adhesive bonding profiles of the example
dispersions with and without starch.

| | | Peel strength [N/25 mm]; | | | | Shear |
|---|---|---|---|---|---|---|
| | Quickstick, | fracture mode | | | | strength, |
| | steel, | 1 min | 24 h | 1 min | 24 h | steel |
| Ex. | [N/25 mm] | steel | steel | HDPE | HDPE | [h] |
| 1a | 2.1 | 1.4; A | 2.6; A | 0.5; A | 2.0; A | >100 |
| 1a^{a} | 1.1 | 1.2; A | 2.1; A | 0.4; A | 0.6; A | >100 |
| 1d^{b} | 3.7 | 2.9; A | 5.1; F | 0.9; A | 1.3; A | >100 |
| 1d^{a,b} | 2.4 | 2.0; A | 4.0; F | 0.3; A | 0.4; A | >100 |
| 3a | 1.2 | 1.6; A | 3.8; F | 0.5; A | 1.2; A | >100 |
| 3a^{a} | 0.8 | 1.0; A | 2.2; F | 0.3; A | 0.4; A | >100 |
| 3b | 1.5 | 2.5; A | 3.7; F | 0.8; A | 0.9; A | >100 |
| 3b^{a} | 1.4 | 1.6; A | 2.1; F | 0.3; A | 0.4; A | >100 |
| 4a | 0.7 | 1.0; A | 3.5; A | 0.3; A | 0.4; A | >100 |
| 4a^{a} | 1.7 | 3.2; A | 4.7; A | 0.9; A | 1.2; A | >100 |

^{a}blended with 1.5% Basonat ® HW 100
^{b}1d is a noninventive, comparative dispersion

1. A pressure-sensitively adhesive protective film formed from a polymer film coated with a crosslinked pressure-sensitive adhesive composition,
the pressure-sensitive adhesive composition comprising at least one pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride,
(iii) optionally further monomers different from (i) and (ii),
wherein:
the emulsion polymerization of the monomers occurs in the presence of at least one saccharified starch,
the pressure-sensitive adhesive composition comprises at least one crosslinker selected from the group consisting of polyisocyanates and polyaziridines, and
the crosslinking reaction brought about by the crosslinker is at an end without the pressure-sensitively adhesive protective film being adhered to a substrate.

2. The protective film according to claim 1, wherein the pressure-sensitive adhesive composition is an aqueous dispersion with pressure-sensitive adhesive polymer dispersed therein, the composition comprising from 0.05 to 10 parts by weight of crosslinker, based on the sum of the weight fractions of the at least one saccharified starch and of the at least one pressure-sensitive adhesive polymer.

3. The protective film according to claim 1, wherein the at least one soft monomer (i) is selected from the group consisting of n-butyl acrylate, ethyl acrylate, 2-ethylhexyl acrylate, and mixtures of these monomers.

4. The protective film according to claim 1, wherein the at least one ethylenically unsaturated acid (ii) is selected from the group consisting of acrylic acid, methacrylic acid and mixtures of these monomers.

5. The protective film according to claim 1, wherein the further monomers are present in an amount of 0 to 30 wt % and are selected from the group consisting of C1 to C20 alkyl acrylates, C1 to C20 alkyl methacrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, monomers comprising hydroxyl groups, (meth)acrylamide, phenyloxyethyl glycol mono(meth)acrylate, glycidyl (meth)acrylate, aminoalkyl (meth)acrylates, diacetoneacrylamide, acetoacetoxyethyl methacrylate, and mixtures of these monomers.

6. The protective film according to claim 1, wherein:
the saccharified starch is present in amounts of 1 to 50 parts by weight, based on 100 parts by weight of monomers of the pressure-sensitive adhesive polymer, and
the saccharified starch has a DE of 1 to 25.

7. The protective film according to claim 1, wherein the weight ratio of saccharified starch to crosslinker in the dispersion is from 1:2 to 100:1.

8. The protective film according to claim 1, wherein the crosslinkers are selected from the group consisting of aliphatic diisocyanates, cycloaliphatic diisocyanates, aromatic diisocyanates, polyisocyanates containing isocyanurate groups and derived from aromatic, aliphatic and/or cycloaliphatic diisocyanates, uretdione diisocyanates having aromatically, aliphatically and/or cycloaliphatically bonded isocyanate groups, polyisocyanates containing biuret groups and having aromatically or aliphatically bonded isocyanate groups, polyisocyanates containing urethane groups and/or allophanate groups and having aromatically, aliphatically, or cycloaliphatically bonded isocyanate groups, polyisocyanates comprising oxadiazinetrione groups, trimethylolpropane tris(beta-aziridino)propionate, neopentyl glycol di(betaaziridino)propionate, glycerol tris(beta-aziridino)propionate, pentaerythritol tetra(betaaziridino)propionate, 4,4′-isopropylidenediphenol di(beta-aziridino)propionate, 4,4′-methylenediphenol di(beta-aziridino)propionate, 1,6-hexamethylene di(N,N-ethyleneurea), 4,4′-methylenebis(phenyl-N,N-ethyleneurea), 1,3,5-tris(omega-hexamethylene-N,N-ethyleneurea) biuret, and mixtures thereof.

9. The protective film according to claim 1, wherein the glass transition temperature of the noncrosslinked adhesive polymer is from −60 to 0° C.

10. The protective film according to claim 1, wherein the pressure-sensitive adhesive composition comprises at least one pressure-sensitive adhesive polymer which is formed by emulsion polymerization from
(i) 60 to 99.9 wt %, based on the sum of the monomers, of at least one soft monomer selected from the group consisting of n-butyl acrylate, ethyl acrylate, 2-ethylhexyl acrylate, and mixtures of these monomers,
(ii) 0.1-5 wt %, based on the sum of the monomers, of at least one monomer selected from the group consisting of acrylic acid, methacrylic acid and mixtures of these monomers, and
(iii) 0 to 30 wt % of monomers different from (i) and (ii), selected from the group consisting of C1 to C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, monomers comprising hydroxyl groups, (meth)acrylamide, phenyloxyethyl glycol mono(meth)acrylate, glycidyl (meth)acrylate, aminoalkyl (meth)acrylates, diacetoneacrylamide, acetoacetoxyethyl methacrylate, and mixtures of these monomers,
wherein:
the emulsion polymerization of the monomers occurs in the presence of at least one saccharified starch in an amount of 0.1 to 50 parts by weight, based on 100 parts by weight of monomers of the at least one pressure-sensitive adhesive polymer, and
the pressure-sensitive adhesive composition comprises at least one crosslinker selected from polyisocyanates and polyaziridines, the weight ratio of saccharified starch to crosslinker in the dispersion being from 1:2 to 100:1.

11. A process for producing protective films, comprising forming a pressure-sensitive adhesive composition comprising at least one pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride, and
(iii) optionally further monomers different from (i) and (ii),
wherein:
the emulsion polymerization of the monomers occurs in the presence of at least one saccharified starch,
the pressure-sensitive adhesive composition comprises at least one crosslinker selected from the group consisting of polyisocyanates and polyaziridines, and
the protective film is a polymer film which is coated with the pressure-sensitive adhesive composition, and the crosslinking reaction brought about by the crosslinker is at an end without the pressure-sensitively adhesive protective film being adhered to a substrate.

12. A pressure-sensitive adhesive composition in the form of an aqueous polymer dispersion comprising at least one dispersed pressure-sensitive adhesive polymer formed by emulsion polymerization from
(i) at least 60 wt %, based on the sum of the monomers, of at least one soft monomer which when polymerized as a homopolymer has a glass transition temperature of less than 0° C.,
(ii) 0.1-5 wt %, based on the sum of the monomers, of at least one ethylenically unsaturated acid or at least one ethylenically unsaturated acid anhydride, and
(iii) optionally further monomers different from (i) and (ii),
wherein:
the emulsion polymerization of the monomers occurs in the presence of at least one saccharified starch,
the pressure-sensitive adhesive composition comprises at least one crosslinker selected from the group consisting of polyisocyanates and polyaziridines, and
the weight ratio of starch to crosslinker in the dispersion being from 1:2 to 100:1.
